(19) United States
(12) Patent Application Publication
(10) Pub. No.: US 2024/0330750 A1
(43) Pub. Date: Oct. 3, 2024

(54) SYSTEM AND METHOD FOR MANAGEMENT OF INFERENCE MODELS BASED ON FEATURE CONTRIBUTION

(71) Applicant: Dell Products L.P., Round Rock, TX (US)

(72) Inventors: OFIR EZRIELEV, Be'er Sheva (IL); TOMER KUSHNIR, Omer (IL); AMIHAI SAVIR, Newton, MA (US)

(21) Appl. No.: 18/193,796

(22) Filed: Mar. 31, 2023

(51) Int. Cl. G06N 20/00

(52) U.S. Cl. CPC G06N 20/00

(57) ABSTRACT

Methods and systems for managing inference models are disclosed. The inference models may be used to provide computer implemented services by generated inferences used in the services. The inference models may be managed by proactively evaluating the inference models as they are updated over time. The inference models may be evaluated using user defined ranges for levels of contribution of features on output generated by the inference models. The user defined ranges may be established using a graphical user interface.

### FIELD

Embodiments disclosed herein relate generally to inference model management. More particularly, embodiments disclosed herein relate to systems and methods to manage inference model management based on feature contribution.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating data flows in accordance with an embodiment.

FIG. 2B shows a diagram illustrating a graphical user interface in accordance with an embodiment.

FIGS. 3A-3B show flow diagrams illustrating methods of managing data collection in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing inference models. The inference models may be used to provide computer implemented services. Inferences generated by the inference models may be used during performance of the computer implemented services.

Over time the inference models may be updated. However, updating the inference models may result in the inference models generated undesirable inferences. To manage the risk associated with updating the inference models, an evaluation process may be performed. The evaluation process may be based on the contribution level of each feature of the inference model to output of the inference model. The contribution levels for the features may be compared to user defined ranges for the contribution levels. Contribution levels that are outside of the user defined ranges may indicate that the inference models are undesirable because, for example, the models may place too much or too little weight on particular features.

The user defined ranges may be established by a user through a graphical user interface. The graphical user interface may present the user with the range over which values of the contribution levels for the features may range. Additionally, the graphical user interface may present the user with graphical representations of the historical values of the contribution levels of the features for previous values of the inference models. The user may, using the presented information, select a sub-range which is allowable for a feature. The user may repeat this process for any number of features to define allowable ranges for the features.

In the event that an updated inference model is found to be undesirable, the inference model may be reverted or other actions may be performed to manage the undesirable inference model.

By doing so, embodiments disclosed herein may improve the likelihood that inference obtained using inference models are desirable. A system may do so by proactively identifying levels of feature contribution for the inference model. Thus, embodiments disclosed herein may address the technical problem of, among others, inference model drift during updating. Proactively identifying contribution levels of features that have drifted out of prescribed ranges, the system may prevent undesirable inferences that reflect the undesired level of contribution on the features from being generated. Consequently, a data processing system in accordance with embodiments may more efficiently marshal limited computing resources by reducing the likelihood of expending computing resources for generation of undesirable inferences.

In an embodiment, a method for managing inference models is disclosed. The method may include obtaining training data usable to update an inference model of the inference models, the inference model being trained using a first training data set; updating operation of the inference model using the training data to obtain an updated inference model; identifying a level of contribution of each feature of the updated inference model on output of the updated inference model; making a determination regarding whether the level of contribution of each feature is within a user defined range; in a first instance of the determination where the level of contribution of each feature is not within the user defined range: remediating the updated inference model to reduce an undesired level of feature bias presented by the updated inference model, and providing computer implemented services using the remediated updated inference model; and in a second instance of the determination where the level of contribution of each feature is within the user defined range: treating the updated inference model as exhibiting a desired level of feature bias, and providing the computer implemented services using the updated inference model.

The method may also include presenting, to a user, a range bar associated with a feature of features of the updated inference model; obtaining, from the user, user input indicating a first position of a first limiter with respect to the range bar; and establishing, based on the position of the first limiter, a user defined range of user defined ranges.

The method may further include, prior to obtaining the user input: presenting, to the user, a level of contribution of the feature on output of the inference model.

The range bar and level of contribution of the feature on the output of the inference model may be presented using a graphical user interface, the graphical user interface representing the range bar as a line and the level of contribution of the feature on the output of the inference model as a graphical element positioned at a reference point on the line.

The reference point may be positioned a distance from one end of the line proportionately based on a ratio of a value of the level of contribution of the feature on the output of the inference model to a maximum value of the level of contribution of the feature.

Remediating the updated inference model may include discarding the updated inference model; and providing the computer implemented services using the remediate updated inference model using the inference model to obtain an inference used in the computer implemented services.

Identifying the level of contribution of each feature of the updated inference model on the output of the updated inference model may include calculating an average marginal contribution of each feature among all possible groups of the features.

The average marginal contribution of each feature among all possible groups of the features may be obtained using the Kernel Shap method.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

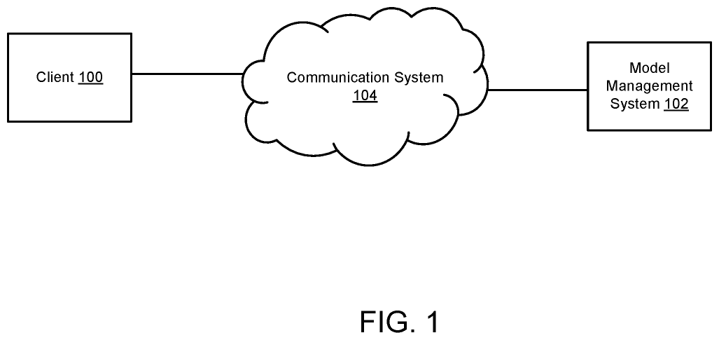

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

The computer implemented services may be provided at least in part using inference models. The inference models may be implemented using machine learning models such as neural networks, decision trees, support vector machines, clustering, and/or other types of learning models.

The inference models may be obtained by (i) obtaining training data (labeled and/or unlabeled) that reflects relationships for which inferences are to be generated, and (ii) generating trained inference models using the training data. Once obtained, the inference models may generate inferences as output for ingest data (e.g., which may include any number and types of features).

Overtime, additional training data may be obtained. The operation of the inference models may be updated using the additional training data. The inferences generated by the updated inference models may reflect the additional information included in the additional training data.

However, updates to inference models may, over time, modify the inference models in undesirable manners. For example, a malicious entity may attempt to inject malicious training data into the update process. If used to update the operation of the inference models, the resulting updated inference models may generate undesired inferences.

If the undesired inferences are used to provide computer implemented services, then the computer implemented services may be undesirable. For example, consider a scenario where an inference model provides inferences regarding future prices of a commodity based on current production information for the commodity. A malicious party may attempt to inject malicious training data into update processes that cause the updated inference models to generate inferences for the future price that may be exploited by the malicious party. A business may use the inferences to drive an automated purchasing process (e.g., a computer implemented service) which, if driven using the inferences from the updated inference model, may be exploited by the malicious party to profit on the automated purchasing process.

In general, embodiments disclosed herein may provide methods, systems, and/or devices for managing inference models. The disclosed systems may manage inference models in a manner that makes the inference models less susceptible to attack by malicious entities and/or generation of undesired inferences due to other causes.

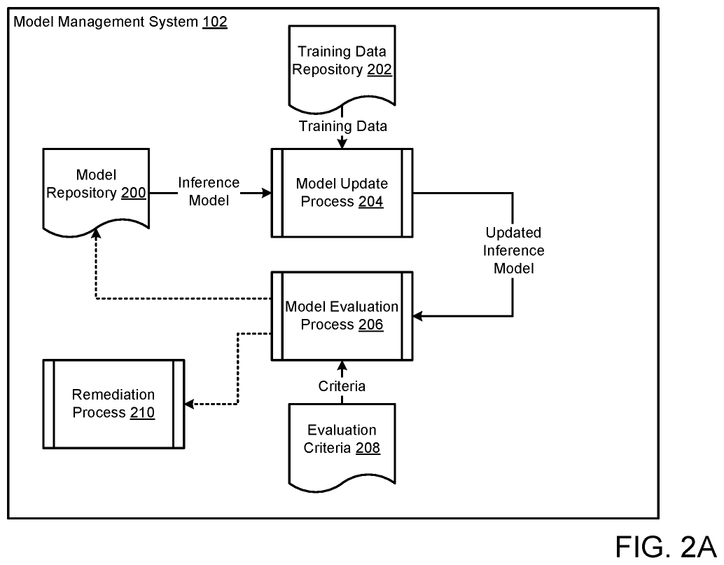

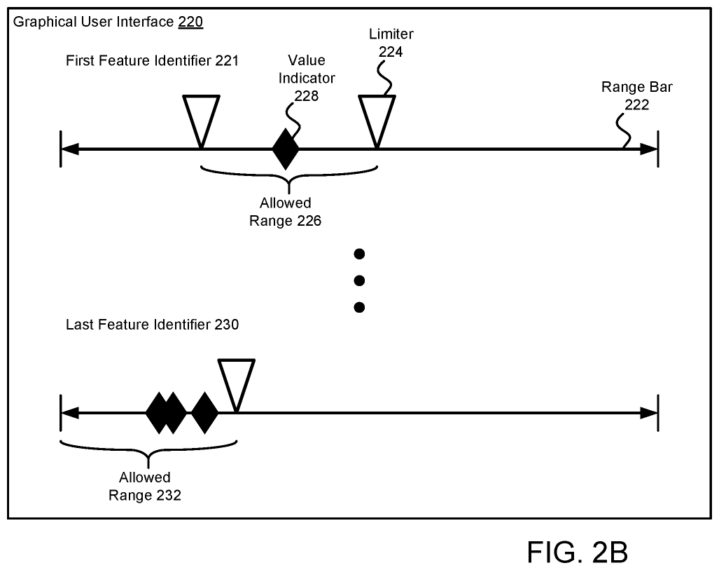

To manage the inference models, the disclosed systems may automatically evaluate the performance of newly updated inference models. The inference models may be evaluated by (i) identifying the importance of each feature of the updated inference model on output produced by the updated inference model, and (ii) comparing the importance to corresponding criteria. If all of the features meet the criteria, then the evaluation may be that the updated inference model is likely to provide desired inferences. If any of the features do not meet the criteria, then the evaluation may be that the updated inference model is unlikely to provide desired inferences. The result of the evaluation may be used to manage the inference models. Refer to FIG. 2A for additional details regarding inference model evaluation.

The criteria for each feature may be obtained using a graphical user interface. The graphical user interface may include interface elements through which a user may indicate acceptable ranges of values for the importance of each feature with respect to output produced by the inference models. Additionally, the graphical user interface may provide information regarding historical importance levels of each of the features with respect to output. The criteria obtained through the graphical user interface may be used, as noted above, to evaluate the updated inference models. Refer to FIG. 2B for additional details regarding criteria.

To provide the above noted functionality, the system of FIG. 1 may include client 100 and model management system 102. Each of these components is discussed below.

Client 100 may provide and/or use computer implemented services. The computer implemented services may utilize inference models, as discussed above. For example, client 100 may host inference models that generate inferences used to provide computer implemented services, may use computer implemented services provided by other entities that utilize inference models, etc.

Model management system 102 may manage inference models. To manage the inference models, model management system 102 may (i) obtain the inference models, (ii) update the inference models, (iii) evaluate the inference models, (iv) rate the inference models based on the evaluation, and (v) manage the inference models based on the ratings. For example, inference models rated below a threshold may be discarded. Refer to FIG. 2A for additional details regarding evaluation and management of inference models.

To evaluate the inference models, model management system 102 may obtain information regarding rating criteria using a graphical user interface. Refer to FIG. 2B for additional details regarding graphical user interfaces.

By managing inference models as disclosed herein, a system in accordance with embodiments may be more likely to provide desired computer implemented services. The computer implemented services may be more likely to be desired because the inferences used in providing the computer implemented services may be more likely to be accurate, fair, ethical, and/or otherwise meet expectations for use in the computer implemented services. The inferences may be more likely to be accurate or meet expectations through evaluation of inference models based on global explainability criteria. The use of global explainability criteria for evaluation may manage drift in the inference model's predictive tendencies over time. By managing drift, the impact of various types of attacks on inference models may be reduced. Thus, embodiments disclosed herein may address, among others, the technical problem of threats present in distributed systems. The disclosed embodiments may address threats present in distributed system may facilitating identification of inference models impacted by the threats. Impacted models may be remediated to address the impact of the threats on the inferences generated by the models.

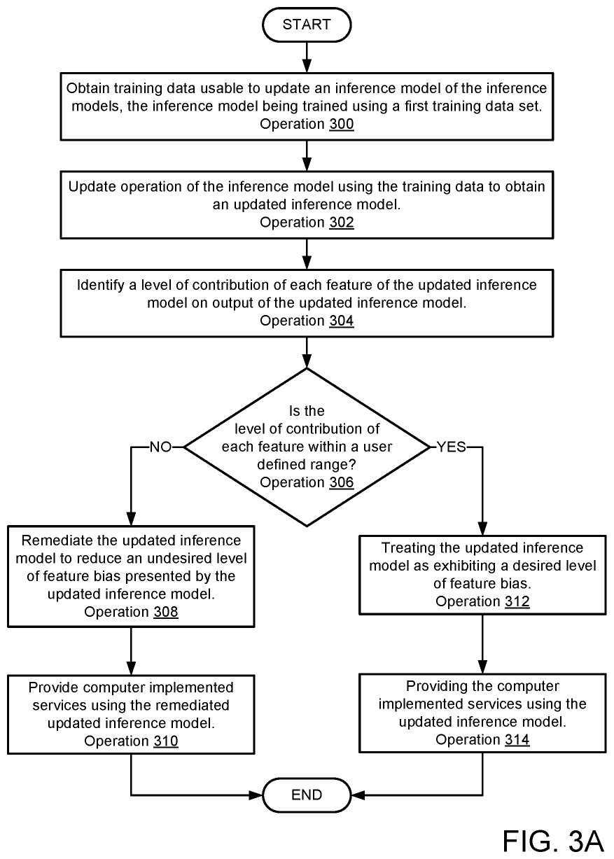

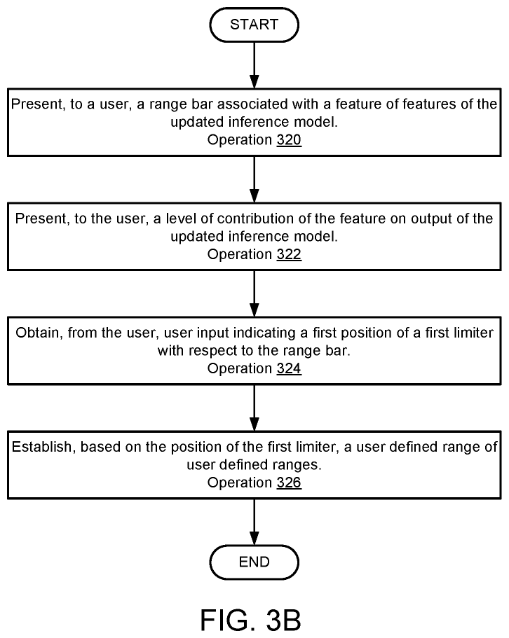

When providing their functionality, any of client 100 and model management system 102 may perform all, or a portion, of the methods illustrated in FIGS. 3A-3B.

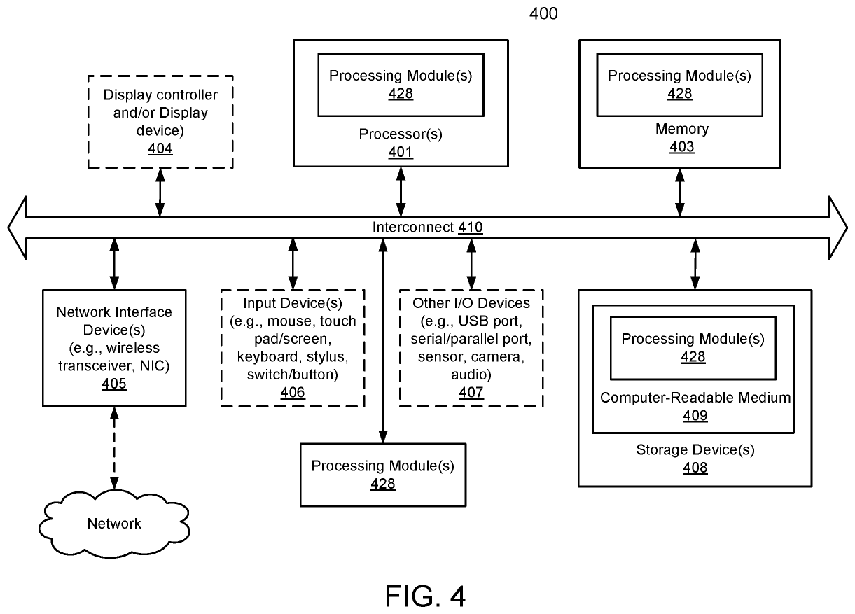

Any of client 100 and model management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Model management system 102 may be implemented with multiple computing devices. For example, model management system 102 may be implemented with a data center, cloud installation, or other type of computing environment.

Any of the components illustrated in FIG. 1 may be operably connected to each other (and/or components not illustrated) with communication system 104. In an embodiment, communication system 104 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein. For example, a system may include any number of instances of client 100, model management system 102, and/or other components not shown in FIG. 1. Any of the instances may perform similar and/or different functions.

To further clarify embodiments disclosed herein, a diagram illustrating data flows implemented by and data structures used by a system over time in accordance with an embodiment is shown in FIG. 2A.

Turning to FIG. 2A, a first data flow diagram illustrating data flows, data processing, and/or other operations that may be performed by the system of FIG. 1 in accordance with an embodiment is shown.

To facilitate computer implemented services using inferences, model management system 102 may (i) maintain, (ii) update, (iii) evaluate, and (iv) retain or remediate inference models used by the system of FIG. 1.

To maintain inference models, model management system 102 may include model repository 200. Any number of inference models may be stored in model repository 200. As inference models are updated over time, samples of the inference models (e.g., that are deprecated) or information usable to revert inference models to previous versions may be retained in model repository 200. Accordingly, if an inference model is updated and the performance of the inference model is undesirable, the inference model may be reverted to a previous state.

To update inference models, model management system 102 may include training data repository 202. Training data repository 202 may include any type and quantity of training data. As new training data becomes available, the new training data may be added to the repository. The training data may be used to (i) train new inference models and (ii) update inference models.

For example, when new training data becomes available, a corresponding inference model and the new training data may be retrieved from the respective repositories 200, 202. Model update process 204 may use the new training data to update weights or other characteristics of the inference model to obtain an updated inference model.

However, as discussed above, some training data may be malicious in nature, may include relationships that if used for training purposes may result in undesired inferences (e.g., such as exhibiting latent bias), and/or may otherwise have undesirable impacts on the inference model during training. For example, the updated inference model may generate inferences that are inaccurate, exhibit latent bias, or may be undesirable for other reasons.

To manage risk associated with updating of inference models (and/or during generation of new inference models), the inference models may be subjected to model evaluation process 206. During model evaluation process 206, the contribution of each feature (e.g., each portion of input ingested by the inference model) to the output of the inference model may be identified. The contribution of each feature may be identified by performing the Shapley Additive Explanations method through which the average marginal contribution of an instance of a feature among all possible groups (or samples of the groups) of features may be identified. For example, a Kernel Shap may be implemented and used to complete Shapley values for each feature.

The resulting values for each feature may indicate the extent of the contribution of each feature on output generated the inference model. The values may be scaled to meet a range.

To ascertain whether an inference model is desirable or undesirable, the contribution of each feature may be compared to corresponding evaluation criteria 208. Evaluation criteria may specify, for each feature, a range of acceptable values. The content of evaluation criteria 208 may be established by a user using, for example, the graphical user interface shown in FIG. 2B. If the values of the contributions for each respective feature is within the corresponding range, then the inference model may be evaluated as being desirable. Otherwise, the inference model may be evaluated as being undesirable.

If the inference model is desirable, the inference model may be added to model repository 200 (e.g., indicated by the dashed line terminating in an arrow and extending from model evaluation process 206 to model repository 200). If the inference model is not desirable, the inference model may be processed for remediation via remediation process 210.

If added to model repository 200, information regarding the inference model and other inference models (e.g., previous versions) may be stored for future use. The information may be used, for example, to revert the model.

If remediation process 210 is performed, the updated inference model may be deleted or otherwise not used for inference generation, and a previous version of the model may be used for inference generation.

Model management system 102 may include any quantity of evaluation criteria. For example, an evaluation criteria for each model may be maintained by model management system 102.

In an embodiment, model management system 102 is implemented using a hardware device including circuitry. The hardware device may be, for example, a digital signal processor, a field programmable gate array, or an application specific integrated circuit. The circuitry may be adapted to cause the hardware device to perform the functionality of model management system 102 as discussed herein. Model management system 102 may be implemented using other types of hardware devices without departing embodiment disclosed herein.

In an embodiment, model management system 102 is implemented using a processor adapted to execute computing code stored on a persistent storage that when executed by the processor performs the functionality of model management system 102 discussed throughout this application. The processor may be a hardware processor including circuitry such as, for example, a central processing unit, a processing core, or a microcontroller. The processor may be other types of hardware devices for processing information without departing embodiment disclosed herein.

In an embodiment, model management system 102 includes storage which may be implemented using physical devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage may include a memory device (e.g., a dual in line memory device) in which data is stored and from which copies of previously stored data are provided. In another example, storage may include a persistent storage device (e.g., a solid-state disk drive) in which data is stored and from which copies of previously stored data is provided. In a still further example, storage may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage may store any of the data structures discussed herein. Any of these data structures may be implemented using, for example, lists, tables databases, linked lists, unstructured data, and/or other types of data structures.

As noted above, the evaluation criteria which may be stored in the storage may be provided by a user.

Turning to FIG. 2B, a diagram of graphical user interface 220 in accordance with an embodiments is shown. Graphical user interface 220 may be used to obtain user input. The user input may be used to establish evaluation criteria for an inference model. Graphical user interface 220 may be presented to the user via a display (e.g., through a data processing system used by the person).

To obtain the user input, graphical user interface 220 may display information regarding features for which criteria is to be established and include graphical elements through which user input may be provided. For example, graphical user interface 220 may be divided into portions corresponding to different features or clusters of features (e.g., chosen by category or dimensionality reduction). Each portion may be identified by a feature identifier (221) which may be a graphical representation of an indicator of a feature.

A range bar (e.g., 222) may be positioned in each portion. The range bar may be a graphical representation of a range over which values for the feature may vary. For example, the range bar in a portion may be implemented using a line (e.g., indicating the extent of the range).

One or more limiters (e.g., 224) may be positioned with the range bar in each portion. The limiters may be graphical elements that allow an allowed range (e.g., 226) to be defined by positioning the limiters along the range bar. The positions of the limiters along the range bars may corresponding to values for the feature that define the allowed range.

The limiters may be interactive. For example, a user may use a pointing device such as a mouse to select a limiter and move its position along the range bar. Through this interaction, the user may define values for the top and/or bottom of an allowed range (e.g., 226) for the contribution of each feature. In some cases, only a single limiter may be positioned on a range bar (e.g., such as shown with respect to the portion in which last feature identifier 230 is positioned). In these cases, the allowed range (e.g., 232) may be, with respect to FIG. 2B, to the left or to the right of the limiter. The allowed range may be established by the user to, for example, prevent a feature from having an undesirably large impact on generated inferences (e.g., which a malicious entity may attempt to exploit) or an undesirably low impact on generated inferences (e.g., which may decrease the accuracy of the model). For example, if the actual value were to fall below the allowed range (e.g., to the left of the allowed range in the figure), the feature may have little influence on inferences and if the actual value were to fall above the allowed range (e.g., to the right of the allowed range in the figure), then the feature may have an outsized influence on inferences thereby allowing a malicious entity to exploit the outsized influence of the feature.

To assist the user in making a selection for the range, one or more value indicators (e.g., 228) may be positioned along range bar 222. The value indicators may be graphical elements that indicate the value of the contribution of the feature in a previous version of the inference model. The value indicators may do so by being located along range bar 222 at a position corresponding to the value. One (e.g., as illustrated with respect to the upper range bar shown in FIG. 2B) or multiple (e.g., as illustrated with respect to the lower range bar shown in FIG. 2B) value indicators corresponding to the feature of previous versions of an inference model may be shown. In this manner, the user may integrate information regarding the contribution of a feature as an inference model has been updated over time when selecting the allowed range for each feature.

Once user input that indicates the allowed range for the contribution of each feature, an evaluation criteria for an inference model may be obtained. For example, the allowed ranges may be aggregated in a data structure.

As discussed above, the components of FIG. 1 may perform various methods to manage operation of data processing systems. FIGS. 3A-3B illustrate methods that may be performed by the components of the system of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method for providing computer implemented services using inference models in accordance with an embodiment is shown. The method may be performed by any of client 100, model management system 102, and/or other components of the system shown in FIG. 1.

Prior to operation 300, training data may be obtained and used to train one or more inference models.

At operation 300, training data usable to update an inference model of the inference models is obtained. The inference model may have been trained using a first training data set (e.g., part of the training data obtained prior to operation 300). The training data may be obtained by (i) receiving it from another device, (ii) generating the training data, (iii) reading the training data from storage, and/or via other methods.

At operation 302, operation of the inference model is updated using the training data to obtain an updated inference model. The operation of the inference model may be updated by using the training data to modify the weights of neurons (e.g., if implemented with a neural network) or other features of the inference model. The weights may be modified using an training process. For example, a global optimization using the training data set and/or new training data may be performed such that the resulting updated inference model generalizes the relationships defined by the training data.

At operation 304, a level of contribution of each feature of the updated inference model on output of the updated inference model is identified. The level of contribution of each feature may be identified by calculating an average marginal contribution of each feature among all possible groups of the features. The average marginal contribution of each feature among all possible groups of the features may obtained using the Kernel Shap method. The values obtained that correspond to each feature may be the level of contribution for the feature.

At operation 306, a determination may be made regarding whether the level of contribution of each feature is within a user defined range. The determination may be made by (i) obtaining the user defined ranges for the features, and (ii) comparing the level of contribution of each feature to the corresponding user define range for the feature.

If all of the levels of contribution are within the user defined ranges, then the method may proceed to operation 312. Otherwise, the method may proceed to operation 308.

At operation 308, the updated inference model is remediated to reduce an undesired level of feature bias presented by the updated inference model. The feature bias may be a level of dependence on output of the updated inference model on a particular feature that is outside of the user defined range for the feature. The updated inference model may be remediated by discarding the updated inference model, and using a previous version of the inference model as the remediated inference model. In other words, the updated inference model may be reverted to the previous or another prior version of the inference model.

At operation 310, the computer implemented services are provided using the remediated updated inference model. The computer implemented services may be provided by (i) initiating generation of inferences using the remediated updated inference model, and (ii) using the generated inferences to provide, at least in part, the computer implemented services. The computer implemented services may ingest or otherwise use the generated inferences to perform various actions as part of the computer implemented services.

The method may end following operation 310.

Returning to operation 306, the method may proceed to operation 312 following operation 306 when the level of contribution of each feature is within the user defined range for the feature.

At operation 312, the updated inference model is treated as exhibiting a desired level of feature bias. The updated inference model may be treated as exhibiting the desired level of feature bias by storing a copy of the updated inference model in a repository for future use or otherwise marking the inference model as acceptable for use in inference generation.

At operation 314, the computer implemented services are provided using the updated inference model. The computer implemented services may be provided similarly to as described with respect to operation 310, but may use inferences obtained using the updated inference model rather than the remediated updated inference model.

The method may end following operation 314.

As discussed with respect to operation 306, user defined ranges may be used to evaluate an inference model (e.g., proceeding to operation 312 may indicate that the inference model is evaluated as being desirable whereas proceeding to operation 308 may indicate that the inference model is evaluated as not being desirable).

Turning to FIG. 3B, a flow diagram illustrating a method obtaining user defined ranges in accordance with an embodiment is shown. The method may be performed by any of client 100, model management system 102, and/or other components of the system shown in FIG. 1.

At operation 320, a range bar associated with a feature of features of an updated inference model is presented to a user. The range bar may be presented to the user by displaying it via a graphical user interface. The graphical user interface may be similar to that shown in FIG. 2B.

At operation 322, a level of contribution of the feature on output of the updated inference model is presented to the user. The level of contribution may be presented to the user by displaying it via a graphical user interface. The level of contribution may be presented using a graphical element positioned along the range bar at a location corresponding to the level of contribution on a scale defined by the length of the range bar. The graphical user interface may be similar to that shown in FIG. 2B.

At operation 324, user input indicating a first position of a first limiter with respect to the range bar is obtained from the user. The user input may be obtained by allowing the user to manipulate a location of the first limiter along the range bar. Location along the range bar may be converted into a corresponding value based on the scale defined by the length of the range bar.

At operation 326, a user defined range is established based on the position of the first limiter. The user defined range may be established by obtaining the value corresponding to the position and adding it to a data structure. The positions of multiple limiters may be used to define upper and lower boundaries of the user defined range (e.g., an allowed range for the feature).

The method may end following operation 326.

The method shown in FIG. 3B may be used to define any number of user defined ranges for any number of features.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing inference models, the method comprising:
obtaining training data usable to update an inference model of the inference models, the inference model being trained using a first training data set;
updating operation of the inference model using the training data to obtain an updated inference model;
identifying a level of contribution of each feature of the updated inference model on output of the updated inference model;
making a determination regarding whether the level of contribution of each feature is within a user defined range;
in a first instance of the determination where the level of contribution of each feature is not within the user defined range:
remediating the updated inference model to reduce an undesired level of feature bias presented by the updated inference model, and
providing computer implemented services using the remediated updated inference model; and
in a second instance of the determination where the level of contribution of each feature is within the user defined range:
treating the updated inference model as exhibiting a desired level of feature bias, and
providing the computer implemented services using the updated inference model.

2. The method of claim 1, further comprising:
presenting, to a user, a range bar associated with a feature of features of the updated inference model;
obtaining, from the user, user input indicating a first position of a first limiter with respect to the range bar; and
establishing, based on the position of the first limiter, a user defined range of user defined ranges.

3. The method of claim 2, further comprising:
prior to obtaining the user input:
presenting, to the user, a level of contribution of the feature on output of the inference model.

4. The method of claim 3, wherein the range bar and level of contribution of the feature on the output of the inference model is presented using a graphical user interface, the graphical user interface representing the range bar as a line and the level of contribution of the feature on the output of the inference model as a graphical element positioned at a reference point on the line.

5. The method of claim 4, wherein the reference point is positioned a distance from one end of the line proportionately based on a ratio of a value of the level of contribution of the feature on the output of the inference model to a maximum value of the level of contribution of the feature.

6. The method of claim 4, wherein remediating the updated inference model comprises discarding the updated inference model; and providing the computer implemented services using the remediate updated inference model using the inference model to obtain an inference used in the computer implemented services.

7. The method of claim 6, where providing the computer implemented services using the updated inference model comprises using the updated inference model to obtain an inference used in the computer implemented services.

8. The method of claim 1, wherein identifying the level of contribution of each feature of the updated inference model on the output of the updated inference model comprises calculating an average marginal contribution of each feature among all possible groups of the features.

9. The method of claim 8, wherein the average marginal contribution of each feature among all possible groups of the features is obtained using the Kernel Shap method.

10. A non-transitory machine-readable medium having instructions stored therein, which when executed by a processor, cause the processor to perform operations for managing data collection for managing inference models, the operations comprising:
obtaining training data usable to update an inference model of the inference models, the inference model being trained using a first training data set;
updating operation of the inference model using the training data to obtain an updated inference model;
identifying a level of contribution of each feature of the updated inference model on output of the updated inference model;
making a determination regarding whether the level of contribution of each feature is within a user defined range;
in a first instance of the determination where the level of contribution of each feature is not within the user defined range:
remediating the updated inference model to reduce an undesired level of feature bias presented by the updated inference model, and
providing computer implemented services using the remediated updated inference model; and
in a second instance of the determination where the level of contribution of each feature is within the user defined range:
treating the updated inference model as exhibiting a desired level of feature bias, and
providing the computer implemented services using the updated inference model.

11. The non-transitory machine-readable medium of claim 10, wherein the operations further comprise:
presenting, to a user, a range bar associated with a feature of features of the updated inference model;
obtaining, from the user, user input indicating a first position of a first limiter with respect to the range bar; and
establishing, based on the position of the first limiter, a user defined range of user defined ranges.

12. The non-transitory machine-readable medium of claim 11, wherein the operations further comprise:
prior to obtaining the user input:
presenting, to the user, a level of contribution of the feature on output of the inference model.

13. The non-transitory machine-readable medium of claim 12, wherein the range bar and level of contribution of the feature on the output of the inference model is presented using a graphical user interface, the graphical user interface representing the range bar as a line and the level of contribution of the feature on the output of the inference model as a graphical element positioned at a reference point on the line.

14. The non-transitory machine-readable medium of claim 13, wherein the reference point is positioned a distance from one end of the line proportionately based on a ratio of a value of the level of contribution of the feature on the output of the inference model to a maximum value of the level of contribution of the feature.

15. The non-transitory machine-readable medium of claim 13, wherein remediating the updated inference model comprises discarding the updated inference model; and providing the computer implemented services using the remediate updated inference model using the inference model to obtain an inference used in the computer implemented services.

16. The non-transitory machine-readable medium of claim 15, where providing the computer implemented services using the updated inference model comprises using the updated inference model to obtain an inference used in the computer implemented services.

17. The non-transitory machine-readable medium of claim 10, wherein identifying the level of contribution of each feature of the updated inference model on the output of the updated inference model comprises calculating an average marginal contribution of each feature among all possible groups of the features.

18. The non-transitory machine-readable medium of claim 17, wherein the average marginal contribution of each feature among all possible groups of the features is obtained using the Kernel Shap method.

19. A data processing system, comprising:
a processor; and
a memory coupled to the processor to store instructions, which when executed by the processor, cause the processor to perform operations for managing data collection for managed devices and unmanaged devices, the operations comprising:
obtaining training data usable to update an inference model of the inference models, the inference model being trained using a first training data set;
updating operation of the inference model using the training data to obtain an updated inference model;
identifying a level of contribution of each feature of the updated inference model on output of the updated inference model;
making a determination regarding whether the level of contribution of each feature is within a user defined range;
in a first instance of the determination where the level of contribution of each feature is not within the user defined range:
remediating the updated inference model to reduce an undesired level of feature bias presented by the updated inference model, and
providing computer implemented services using the remediated updated inference model; and
in a second instance of the determination where the level of contribution of each feature is within the user defined range:
treating the updated inference model as exhibiting a desired level of feature bias, and
providing the computer implemented services using the updated inference model.

20. The data processing system of claim 19, wherein the operations further comprise:
presenting, to a user, a range bar associated with a feature of features of the updated inference model;
obtaining, from the user, user input indicating a first position of a first limiter with respect to the range bar; and
establishing, based on the position of the first limiter, a user defined range of user defined ranges.
